(19) United States
(12) Patent Application Publication
(10) Pub. No.: US 2022/0286347 A1
(43) Pub. Date: Sep. 8, 2022

(54) COMPRESSED BIDIRECTIONAL FORWARDING DETECTION CONTROL PACKETS

(71) Applicant: ARRIS Enterprises LLC, Suwanee, GA (US)

(72) Inventor: Kiran Kalidevapura Thimmappa, Bangalore (IN)

(73) Assignee: ARRIS Enterprises LLC, Suwanee, GA (US)

(21) Appl. No.: 17/685,555

(22) Filed: Mar. 3, 2022

Related U.S. Application Data
(60) Provisional application No. 63/156,630, filed on Mar. 4, 2021.

(51) Int. Cl. H04L 41/06; H04L 45/02

(52) U.S. Cl. CPC H04L 41/06; H04L 45/026

(57) ABSTRACT

Transmitting hello packets within a network to indicate a status of a device or of a path between devices may use a relatively large amount of memory, for example where the packets are transmitted frequently. Methods, systems, and devices with smaller packet payloads are provided. Methods may include: detecting, by a first device, a configuration state present within a network to which the first device is connected; selecting, by the first device and based on the detected configuration state, between a first format and a second format to be used in generating a hello packet for transmission via the network to a second device, wherein the first format requires at least one field that is absent from the second format; generating, by the first device, the hello packet according to the selected first or second format; and transmitting, by the first device, the generated hello packet to the network.

### CROSS-REFERENCE TO RELATED APPLICATION

The present application claims the benefit of priority to U.S. Provisional Application No. 63/156,630, filed on Mar. 4, 2021, and the entire contents of the above-identified application are incorporated by reference as if set forth herein.

### TECHNICAL FIELD

The present disclosure is related to networking systems, and in particular relates to using compressed bidirectional forwarding detection control packets in networking systems.

### BACKGROUND

Routers are computer-implemented devices that determine which communication link or links to employ to support the progress of data through a network or networks, such as local area networks (LANs), wide area networks (WANs), and/or the Internet. A router is a network node that determines which link to use to transfer data based on information in the network and in the data to be transferred. Routers typically operate at the network layer (Open Systems Interconnection (OSI) Layer 3).

Routing protocols enable each router to identify another router that is the “next hop” that a packet should take towards its destination. There are two different classes of gateway protocols that are used to exchange information between routers, namely “exterior” and “interior” gateway protocols. Exterior gateway protocols, such as Border Gateway Protocol, facilitate information exchange between different autonomous systems. Interior gateway protocols (“IGPs”) facilitate information exchange within an autonomous system. IGPs may be further subdivided into “link-state routing protocols” in which each router generates a map of every connection in the network and may select a “best” path from among multiple paths towards a destination, and “distance vector routing protocols” where each router has information only about the “best” next hop towards the destination. Different routing protocols may be selected and used based on network size, bandwidth availability, ease of configuration, and so on. Additionally, in some instances an operator can manually override the automated “dynamic” routing with a “static” route.

Some examples of link state routing protocols are the Open Shortest Path First Protocol (“OSPF”), and the Intermediate System to Intermediate System (“IS-IS”). Some link state routing protocols use a “hello” protocol (e.g., the OSPF hello protocol) to acquire neighbors. Each router identifies its neighbors by exchanging hello packets with other routers.

In addition to helping acquire neighbors, hello packets also act as “keepalives,” which are messages that let neighbor routers know that the path between the routers and the routers themselves are still functional. If a first router does not receive a preset number of hello packets from a second router during a predetermined time period, then the first router assumes that either the second router or the path between the first and second routers is non-functional. The first router can then switch over to a different path to the second router, or start routing network traffic to a third router. Failures of both equipment and communication paths is referred to herein as “link failure.”

The OSPF hello protocol typically results in a router detecting a link failure on a timescale of seconds (e.g., 1-50 seconds), depending on the number of missed Hello packets and the interval between them before the receiving router can assume that the link has failed. For some network traffic, such as video or voice traffic, this timescale may be too long, and faster detection of non-functional links or routers is required.

To provide sub-second timescale detection of link failures, some networks are configured to use a Bidirectional Forwarding Detection (“BFD”) protocol. The BFD protocol is able to detect link failures on timescales ranging from microseconds to milliseconds, depending on configuration. BFD is independent from the routing protocol, and thus routing protocols such as those discussed above can be configured to use BFD instead of their own link failure detection protocols.

BFD is a hello protocol with some similarities to the OSPF hello protocol, and the BFD control packets may be considered a type of hello packet, which again are messages that let neighbor routers know that the path between the routers and the routers themselves are still functional. In BFD, a BFD session is established between two systems for a bidirectional path between the two systems. As part of establishing the BFD session, each system estimates how quickly it can send and receive BFD control packets and negotiates with the other system to come to an agreement as to how rapidly to send the control packets. A lower BFD failure detection timer value will yield a faster failure detection, and a higher BFD failure detection timer will yield a slower failure detection, although setting the BFD failure detection timer too low may cause the BFD session to fail without merit.

Once the BFD session is established, the two systems will usually operate in an “asynchronous” mode, and periodically send BFD control packets to each other on the path, and the state of the link may be designated as “up.”

FIG. 1 illustrates an example networking system 100, in which a first system 10 and second systems 20 (which may be routers in the networking system 100) communicate via a primary path 30 and a secondary path 40. Additional network equipment, such as switches 35-1, 35-2, and 35-3 may be present within the networking system 100 and, as shown, along the paths 30 and 40. Routing protocol components 11 and 21 (e.g., OSPF components) respectively within each of the first and second systems 10 and 20 may specify that the primary path 30 is to be used bidirectionally for communications between the first and second systems 10 and 20.

Additionally, a BFD session may be enabled by respective BFD components 12 and 22 of the first and second systems 10 and 20 for the primary path 30. Accordingly, BFD control packets (and OSPF hello packets, if used) may be generated by the BFD components 12 and 22 and transmitted to a respective packet egress queue or pool 13 and 23 within the first and second systems 10, 20. The packet egress queue or pool 13, 23 may be within a respective memory 15, 25, in the first and second systems 10 and 20. The BFD control packets are then communicated to the reciprocal system 10 or 20 via the primary path 30 and are received in a packet ingress queue or pool 14 and 24, which may also be within the memory 15, 25. The received BFD control packets are then retrieved from the packet ingress queue or pool 14 and 24 for processing by the BFD component 12, 22 of the receiving system 10, 20.

If the first system 10 does not receive a BFD control packet from the second system 20 within a time interval, or if the second system 20 fails to respond to a demand from the first system 10, then the BFD component 12 of the first system 10 may assume that a failure has occurred on the primary path 30. The BFD component 12 of the first system 10 may designate the link as “down,” and may raise an appropriate signal to the routing protocol component 11 of the first system 10, and the routing protocol component 11 may cause the first system 10 to fail over to using the secondary path 40 for communicating network traffic to the second system 20. A similar process may occur if the second system 20 does not receive a BFD control packet from the first system 10 within the time interval, or if the first system 10 fails to respond to a demand from the second system 20.

It is increasingly common for a link between two routers or network devices (e.g., systems 10 and 20 of FIG. 1) to be formed from multiple physical connections, which can provide both increased redundancy and/or throughput between the routers. These multiple physical connections can be combined into a single logical unit called a Link Aggregation Group (LAG). FIG. 2 shows that in the networking system 100′, the primary path 30 between the two systems 10 and 20 may comprise eight separate physical network connections 32-1 through 32-8 between the systems 10 and 20. The network connections 32-1 through 32-8 may together comprise a LAG 30, and the network connections 32-1 through 32-8 may be referred to as member links of the LAG 30. In FIG. 2, the switches 35-1, 35-2, and 35-3 are omitted for ease of illustration.

If a network operator chooses to enable BFD on the LAG 30, then a separate BFD session must be established for each network connection 32-1 through 32-8 between systems 10 and 20. These separate BFD sessions are referred to as micro-BFD sessions. Micro-BFD sessions provide the BFD components 12 and 22 of the first and second systems 10 and 20 with the ability to verify link continuity for every member link 32-1 through 32-8 of the LAG 30, as well as the ability to verify link continuity of the overall LAG 30. The state of each micro-BFD session is analyzed separately. If the micro-BFD session state for all member links 32-1 through 32-8 is down, then the BFD state of the overall LAG 30 is marked as down and all applications and protocols participating in the BFD session are notified. So long as one micro-BFD session for one member link 32-1 through 32-8 is “up,” then the BFD state of the overall LAG 30 is marked as “up.”

### SUMMARY

Some aspects of the present disclosure provide methods, systems, and devices in which a packet is generated according to a selected one of a first format or a second format. For example, some aspects of the present disclosure provide a method, which may include: detecting, by a first device, a configuration state present within a network to which the first device is connected; selecting, by the first device and based on the detected configuration state, between a first format and a second format to be used in generating a hello packet for transmission via the network to a second device, wherein the first format requires at least one field that is absent from the second format; generating, by the first device, the hello packet according to the selected first or second format; and transmitting, by the first device, the generated hello packet to the network.

Some aspects of the present disclosure provide networking systems. For example, a networking system according to the present disclosure may include a first networking device; and a second networking device in communication with the first networking device via a network. The first networking device may be configured to: detect a configuration state present within the network; select, based on the detected configuration state, between a first format and a second format to be used in generating a hello packet for transmission via the network to the second networking device; generate the hello packet according to the selected first or second format; and transmit the hello packet to the network. The first format may require at least one field that is absent from the second format.

Another example of a networking system according to the present disclosure may include a first networking device configured to: detect a configuration state present within a network; select, based on the detected configuration state, between a first format and a second format to be used in generating a hello packet for transmission via the network to a second networking device; generate the hello packet according to the selected first or second format; and transmit the hello packet to the network. The first format may require at least one field that is absent from the second format.

In some embodiments, the hello packet may be a bidirectional forwarding detection protocol (BFD) control packet. In some embodiments, the detecting of the configuration state present within the network may include detecting that the first device is establishing a BFD session with the second device, and the selecting between the first format and the second format may include selecting the first format. In some embodiments, the detecting of the configuration state present within the network may include detecting that the first device or the second device is requesting a configuration change to an established BFD session between the first device and the second device, and the selecting between the first format and the second format may include selecting the first format. In some embodiments, the requesting of the configuration change to the established BFD session may be responsive to user input.

In some embodiments, the first format may include a field for a discriminator value corresponding to the first device, and the field for the discriminator value corresponding to the first device may be absent from the second format. In some embodiments, the first format may include a field for a minimum BFD control packet transmission interval value desired by the first device, and the field for the minimum BFD control packet transmission interval value desired by the first device may be absent from the second format. In some embodiments, the first format may include a field for a minimum BFD control packet reception interval value supported by the first device, and the field for the minimum BFD control packet reception interval value required by the first device may be absent from the second format. In some embodiments, the first format may include a field for a minimum BFD echo packet transmission interval value required by the first device, and the field for the minimum BFD echo packet transmission interval value required by the first device may be absent from the second format.

In some embodiments, the first device and the second device may be in communication with each other over multiple physical links. In some embodiments, the first device and the second device may be in communication with each other via a link aggregation group (LAG).

Other aspects and embodiments of the present disclosure will be apparent from review of the detailed description of the inventive concepts provided herein.

### BRIEF DESCRIPTION OF THE FIGURES

FIG. 1 is a block diagram illustrating aspects of a networking system.

FIG. 2 is a block diagram illustrating aspects of a networking system.

FIG. 3 illustrates an uncompressed and/or untruncated BFD control packet format.

FIG. 4 is a block diagram illustrating aspects a networking system in which components thereof are configured to select and use a compressed and/or truncated BFD control packet when appropriate, according to some embodiments of the present inventive concepts.

FIG. 5 illustrates a compressed and/or truncated BFD control packet format, according to some embodiments of the present inventive concepts.

FIG. 6 is a flowchart illustrating aspects of methods of selecting whether to generate a hello packet according to a first packet format or according to a second format, where the first format includes at least one field absent from the second format.

FIG. 7 is a block diagram illustrating an electronic device in accordance with an embodiment of the present disclosure.

FIG. 8 is a block diagram illustrating aspects a networking system in which components thereof are configured to select and use a compressed and/or truncated BFD control packet when appropriate, according to some embodiments of the present inventive concepts.

FIG. 9 is a flowchart illustrating aspects of methods of selecting whether to generate a hello packet according to a first packet format or according to a second format, where the first format includes at least one field absent from the second format.

Note that like reference numerals refer to corresponding parts throughout the drawings. Moreover, multiple instances of the same part may be designated by a common prefix separated from an instance number by a dash.

### DETAILED DESCRIPTION

Although BFD may represent a potential improvement over other link failure detection algorithms (e.g., OSPF hello protocol), the present application is based on the recognition that a network and/or resources of the network may be adversely impacted by some BFD sessions, in particular those in which micro-BFD sessions for a LAG interface are being employed.

Part of this adverse impact stems from the relatively large size of the BFD control packet, which is defined by a standards document promulgated by the Internet Engineering Task Force (IETF) in Request for Comments (RFC) 5880. The contents of IETF RFC 5880 are incorporated by reference herein.

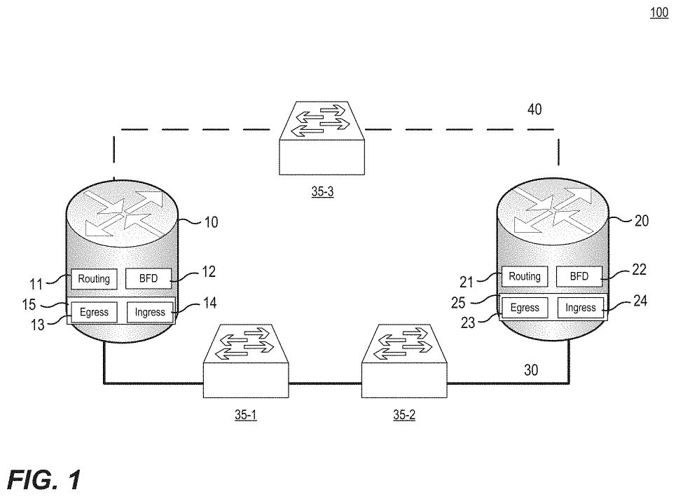

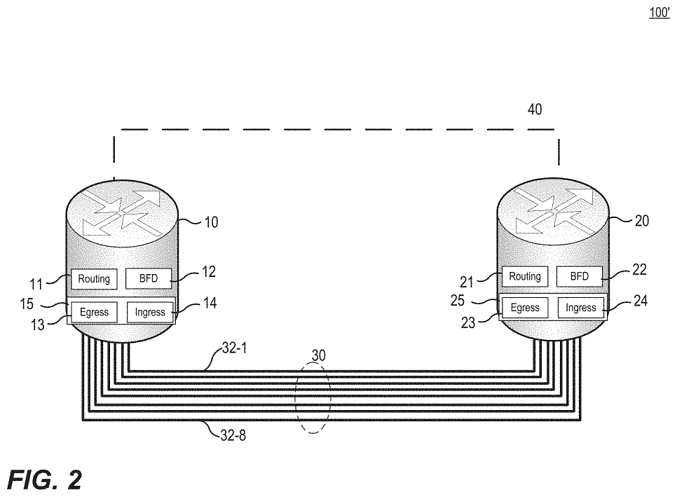

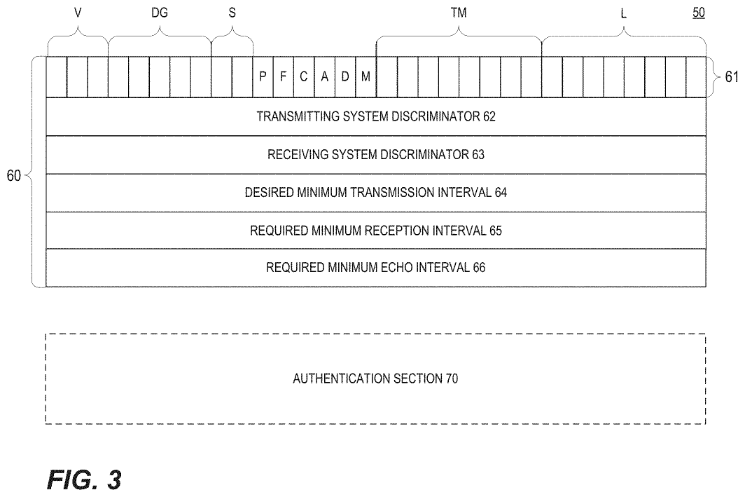

A BFD control packet format according to RFC 5880 is at least 24 bytes. FIG. 3 illustrates the format of a BFD control packet 50 as transmitted by the first system 10 in the system of FIG. 1 or FIG. 2. In other words, the transmitting system of the BFD control packet 50 of FIG. 3 is the first system 10, and the receiving system of the BFD control packet 50 of FIG. 3 is the second system 20. Similar BFD control packets may be transmitted by the second system 20 of FIG. 1 or FIG. 2.

The format of a BFD control packet 50 according to RFC 5880 has a mandatory section 60 and an optional authentication section 70. The mandatory section 60 of a BFD control packet 50 includes a four-byte header 61, a four-byte transmitting system discriminator 62, a four-byte receiving system discriminator 63, a four-byte desired minimum control packet transmission interval 64, a four-byte required minimum control packet transmission interval 65, and a four-byte transmitting system required minimum echo packet transmission interval 66.

The header 61 includes a three-bit version number field V that specifies the packet format version of the control packet 50, a five-bit diagnostic code D that specifies the reason for the last change in its session state of the transmitting system 10, and a two-bit state value S that indicates the current BFD session state as seen by the transmitting system 10. The header 61 also includes a poll bit P, which if set indicates that the transmitting system 10 is requesting verification of connectivity, or of a parameter change, and is expecting a return packet with the final (F) bit set in reply (to verify the connectivity or parameter change). The header 61 also includes a control plane bit C that indicates the BFD session is implemented in a control plane or is implemented in a forwarding plane, and an authentication bit A that indicates that the authentication section 70 is present in the BFD control packet 50, and that the session is to be authenticated. Other values present in the header 61 include a demand bit D that indicates whether the transmitting system 10 is operating in the demand mode and a reserved multipoint bit M for future extension, and a one-byte length field L that indicates the length of the BFD control packet, in bytes. Finally, a one-byte multiplier TM is used to indicate, in effect, the number of BFD control packets that have to be missed in a row to declare the session to be down.

The four-byte transmitting system discriminator field 62 (which is sometimes called the “My Discriminator” field) holds a unique, nonzero discriminator value generated by the transmitting system 10. When a BFD control packet is received by the BFD component 22 in the receiving system 20, it copies the value from the four-byte transmitting system discriminator field 62 into memory. When the BFD component 22 generates a packet for the BFD session for transmission to the transmitting system 10, the BFD component echoes the transmitting system value (from field 62) in in the four-byte receiving system discriminator field 63. The four-byte receiving system discriminator field 63 is sometimes called the “Your Discriminator” field. When the BFD control packet 50 is received by the BFD component 12 of system 10, the value in four-byte receiving system discriminator field 63 is used to demultiplex and associate the control packet 50 to the appropriate BFD session. Likewise, the receiving system 20 generates its own four-byte transmitting system discriminator value (My discriminator) in field 62 which is then echoed back by transmitting system 10 in subsequent packets within receiving system discriminator field (Your discriminator) 63, and the value in this field 63 is used by system 20 to demultiplex and associate the packet to the appropriate BFD session.

The four-byte desired minimum control packet transmission interval 64 is the time interval in microseconds that the transmitting system 10 would like to use when transmitting BFD control packets 50, and the four-byte required minimum control packet transmission interval 65 is the time in microseconds that the transmitting system 10 is capable of supporting when receiving BFD control packets 50. A detection timer may be computed as the product of the one-byte multiplier TM (received from the other system 20) and the greater of the last received four-byte desired minimum control packet transmission interval 64 (received from the other system 20) and the four-byte required minimum control packet reception interval 65 of transmitting system 10. In other words, a detection timer may be the period of time in which the first or second system 10, 20 may go without receiving BFD control packets 50, after which the BFD session is determined to have failed.

The four-byte desired minimum echo packet transmission interval 66 is used when the BFD session between the first and second systems 10 and 20 uses an echo function defined in the BFD RFC. When the echo function is active, a stream of BFD echo packets may be transmitted from the transmitting system 10 to be looped back by the receiving system 20 through a forwarding path of the receiving system 20. If a pre-specified number of packets of the echoed data stream are not received (e.g., 1), then the session is declared to be down. The echo function may be used with either asynchronous mode or demand mode.

If present, the optional authentication section 70 may indicate one of a number of different types of authentication (e.g., password, MD5, Secure Hash Algorithms (SHA), etc.) and may provide the receiving system 20 the data needed to support the indicated type of authentication.

Some BFD sessions may warrant and implement aggressive timings (e.g., very short desired minimum control packet transmission signal intervals) to rapidly identify failed paths. Configurations in such BFD sessions may include desired minimum control packet transmission intervals 64 of as low as low as 3.3 ms (milliseconds), with a TM multiplier of ×3 (i.e., a detection time of 9.9 ms). This desired minimum control packet transmission interval results in transmission rate in a single direction of ˜300 packets per second. Even more aggressive timing, or in other words, even higher packet per second rates, may be used.

However, because a BFD control packet format according to RFC 5880 is at least 24 bytes, a transmission rate in a single direction of ˜300 packets per second results in memory consumption in the transmitting system 10 in the packet egress queue 13 of approximately 7.2 KB (300×24 B), and because ˜300 BFD control packets per second are being received by the transmitting system 10 (from the other system 20), memory is consumed in the transmitting system 10 in the packet ingress queue 14 at approximately 7.2 KB as well. In other words, every second, an additional 7.2 KB of data may be introduced into both the packet egress queue 13 and the packet ingress queue 14.

As discussed above, BFD sessions are established for each physical path. Accordingly, for some LAGs such as the 8-member LAG 30 of FIG. 2, the total rate of memory consumption may be up to 115.2 KB/s, or 4800 packets per second (8 links*(300 transmitted packets per second+300 received packets per second))*24 B per packet.

This memory usage may result in “back pressure” in the egress queue 13 and/or ingress queue 14, resulting in packet drops. In other words, if these queues 13, 14 are not processed correctly or quickly enough, and if these queues 13, 14 are not sized to handle these data rates, then the queues 13, 14 may overfill, resulting in BFD control packet loss. This back pressure may arise especially where the egress queue 13 and/or ingress queue 14 are shared by multiple protocols (e.g., the BFD protocol and the OSPF hello protocol share the queues 13, 14). Back pressure in either the egress queue 13 or ingress queue 14 can result in protocol “flaps,” where the state of a BFD session (for a single path, for a member link in a LAG, and/or for the LAG itself) is incorrectly marked as “down,” when in fact there is no failure in the path. Such flaps may be referred to as false positive BFD protocol flaps. These BFD false positive protocol flaps may not only result with the potential change in the routing (e.g., failing over from a primary path to a secondary path), but may also result in scenario where generated BFD control packets for a “down” BFD session are still in the egress queue 13 and are transmitted from the transmitting system 10 only to be dropped by the receiving system 20, increasing memory pressure.

The present disclosure is based in part on a recognition that implementation of less-aggressive timings (say, 30 ms or 300 ms) may not be acceptable, as it may result in not only less-rapid identification of failed paths, but may also hamper the convergence time for the BFD components of the two systems, resulting in longer times to negotiate the settings for the BFD session.

The present disclosure is also based in part on the recognition that in certain network scenarios, e.g., when the network is stable, many fields of the BFD control packet 50 format are unnecessary.

Accordingly, aspects of the present disclosure provide methods and systems in which certain network scenarios are detected where a different format or compressed format of the BFD control packet may be used rather than the full format of RFC 5880. In the different format, some fields may be omitted, including those that are required in the full format. BFD control packets that omit these fields may be generated according to the compressed format and then transmitted. Such BFD control packets may be referred to as truncated or compressed BFD control packets.

Additionally, the present disclosure recognizes that some network scenarios may require the full format of RFC 5880, and as such aspects of the present disclosure include detecting such network scenarios and generating and transmitting BFD control packets corresponding to the full format when such network scenarios are present. Such BFD control packets may be referred to as untruncated or uncompressed BFD control packets.

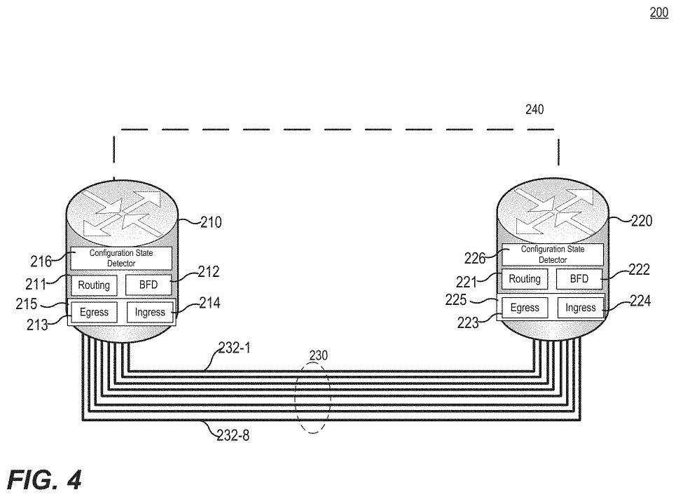

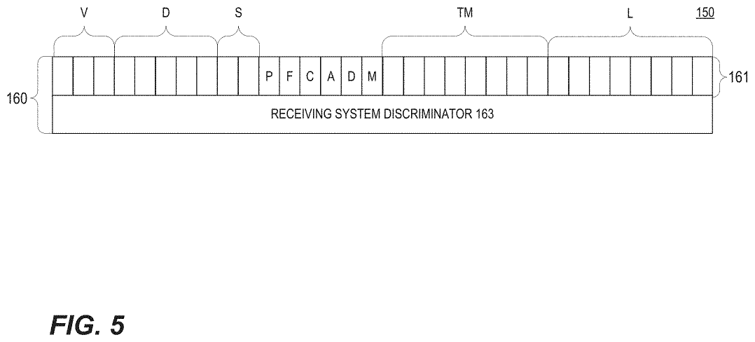

FIG. 4 is a block diagram illustrating aspects a networking system where components thereof are configured to select and use a compressed and/or truncated BFD control packet when appropriate, and FIG. 5 illustrates a compressed and/or truncated BFD control packet format, according to some embodiments of the present inventive concepts.

As seen in FIG. 4, within the networking system 200, a first system 210 and a second system 220 (which may be routers in the networking system 100) communicate via a first path 230 and a second path 240. Each of the first and second paths 230, 240 may be LAGs and may comprise multiple physical links between the two systems 210, 220. For example, first path 230 is shown as an 8-member LAG comprising member links 232-1 to 232-8. Additional network equipment, such as switches may be present within the networking system 200 and along the first and second paths 230, 240, although this equipment is not shown in FIG. 4. Further, components other than those illustrated may be present within the first and second systems 210, 220, although these components are not shown in FIG. 4 for ease of illustration.

Within the first system and second systems 210, 220, respective routing protocol components 211 and 221 (e.g., OSPF components) may be provided, and these components may be configured to select among the paths 230, 240 for communications between the first and second systems 210 and 220. Each of the first and second systems 210, 220 may also include a respective BFD component 212 and 222, which may be configured to establish a BFD session on physical links established between the two systems 210, 220. The BFD components 212 and 222 may be configured to generate BFD control packets, which may be provided to a respective packet egress queue or pool 213 and 223 within the first and second systems 210, 220. The BFD components 212 and 222 may also be configured to retrieve and process delivered BFD control packets, which may be retrieved from a respective packet ingress queue or pool 214 and 224 within the first and second systems 210, 220. The packet egress queues 213, 223, and the packet ingress queues 214, 224 may reside in a memory 215, 225, respectively within the first and second systems 210 and 220.

In some embodiments, for example as shown in FIG. 4, the BFD components 212 and 222 may also be configured to receive an indication of detected configuration state or conditions from a configuration state detector component 216, 226, and the BFD components 212 and 222 may be configured to select between generating compressed BFD control packets or uncompressed BFD control packets in response thereto. The BFD components 212 and 222 may be configured to select between compressed and uncompressed BFD control packet generation responsive to an indication that configuration settings of the first and second systems 210, 220 indicate that compressed BFD control packets should be generated after establishment of a BFD session (e.g., after initialization or bootstrapping of the BFD session). In some embodiments, the configuration state detector components 216, 226 may be integrated within the respective BFD components 212, 222.

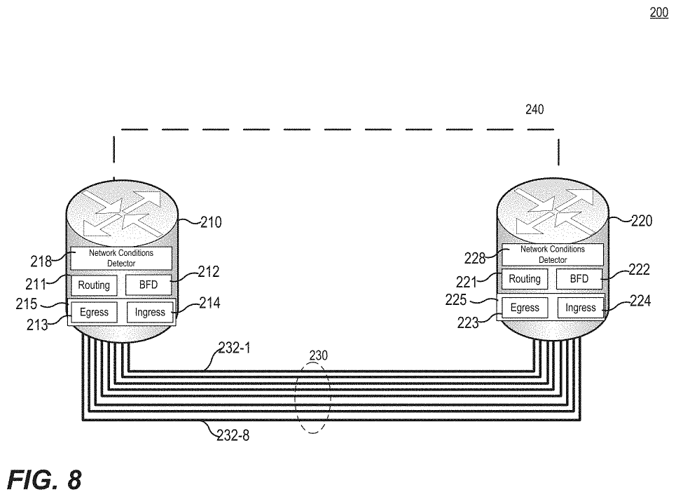

In some embodiments, for example as shown in FIG. 8, the BFD components 212 and 222 may also be configured to receive an indication of detected network situations or conditions from a network situation detector component 218, 228, and the BFD components 212 and 222 may be configured to select between generating compressed BFD control packets or uncompressed BFD control packets. The BFD components 212 and 222 may be configured to select between compressed and uncompressed BFD control packet generation responsive to an indication that network conditions support compressed BFD control packets and/or responsive to an indication that network conditions do not support compressed BFD control packets.

The network condition detector components 218, 228 may be configured to detect configuration states, network conditions and/or situations where compressed BFD control packets and/or uncompressed BFD control packets are appropriate, and accordingly indicate the same to the BFD components 212 and 222. In some embodiments, the network condition detector components 218, 228 may be integrated with the BFD components 212, 222. For example, the network condition detectors 218, 228 may detect that a BFD session is being initially established between the BFD components 212, 222, and accordingly indicate that uncompressed BFD control packets should be used. As another example, the network condition detectors 218, 228 may detect that re-configuration of an established BFD session (e.g., a configuration change)) is being requested by either of the BFD components 212, 222, and accordingly indicate that uncompressed BFD control packets should be used. In some embodiments, the configuration change may be received responsive to user input. As another example, the network may be relatively unstable and undergoing network flapping or route flapping, where components within the networking system 200 (including in some embodiments the first and second systems 210, 220) have not converged on a network routing topology and/or routing table updates are alternating between two different routes to a host. Accordingly, the network condition detectors 218, 228 may detect such network flapping and/or network instability and indicate that uncompressed BFD control packets should be used. The present disclosure is not limited to these examples.

Additionally, or alternatively, the network condition detectors 218, 228 may indicate that conditions exist within the networking system 200 that permit the usage of compressed BFD control packets. For example, when a BFD session has been established, no configuration change is requested, and there is no network flap or route flap, conditions within the networking system 200 may allow for compressed BFD control packets to be generated and transmitted. As another example, the network condition detectors 218, 228 may detect a lack of changes to the rate at which BFD control packets are communicated during a certain time interval, which may indicate sufficient network stability such that compressed BFD control packets may be generated and transmitted.

In some embodiments, the configuration state detector component 216, 226 of FIG. 4 and the network situation detector component 218, 228 of FIG. 8 may both be present in the systems 210 and 220. For example, the configuration state detector components 216, 226 may detect whether a current configuration state permits the usage of compressed BFD control packets, and the network situation detector component 218, 228 may detect when the permitted compressed BFD control packets may in fact be generated. If the configuration detector components 216, 218 detect that the current configuration state does not permit the usage of compressed BFD control packets, or the network situation detector component 218, 228 detects that the compressed BFD control packets should not be generated, then uncompressed BFD control packets may be generated.

An example format of a compressed BFD control packet 150 is shown in FIG. 5. The compressed BFD control packet 150 includes header 161, which includes fields V, DG, S, P, F, C, A, D, M, TM, and L, each of which may be similar to the corresponding field of the uncompressed BFD control packet 50 of FIG. 3 as described above. The compressed BFD control packet 150 may also include the four-byte receiving system discriminator 163, which corresponds to the four-byte receiving system discriminator 63 of the uncompressed BFD control packet 50 of FIG. 3 as described above.

During periods of network stability, many of the large fields of the BFD control packet 50 of FIG. 3 are not needed. For example, once a BFD session is established and the four-byte transmitting system discriminator 62 and four-byte receiving system discriminator 63 have been exchanged, all further received packets are demultiplexed based on the receiving system discriminator 63 only, and the four-byte transmitting system discriminator 62 is not used (or used only for security or authentication purposes). Similarly, when the network is stable, the transmission rate of BFD control packets may converge to an agreed-upon value, and values in the four-byte desired minimum control packet transmission interval 64 and the four-byte required minimum control packet reception interval 65 do not result in changes to the rate at which packets are communicated. The value within the four-byte required minimum echo packet reception interval 66 is used only when the BFD session between the first and second systems 10 and 20 uses an echo function as defined in the BFD RFC. Accordingly, in some embodiments the compressed BFD control packet 150 of FIG. 5 may omit one or more of the four-byte transmitting system discriminator 62, the four-byte desired minimum control packet transmission interval 64, the four-byte required minimum control packet reception interval 65, and the four-byte required minimum echo packet reception interval 66. If each of these fields are omitted, then the compressed BFD control packet 150 of FIG. 5 may have an 8-byte size that is one-third as large as the 24-byte size of the uncompressed BFD control packet 50 of FIG. 3. This may reduce memory usage within each system 210, 220 for each physical link in each direction from, e.g., 7.2 KB/s (for 300 packets per second at 24 B) to e.g., 2.4 KB/s (for 300 packets per second at 8 B) based on a detection timer interval of 3.3 ms×3, which is an aggressive but acceptable timer. Stated differently, when the network is stable and there is no network churn and/or flap, a BFD session may be able to function appropriately with only 8 bytes of packet control data instead of the 24 bytes of the RFC 5880 format. In other words, full BFD functionality may be achieved with only 8 bytes of control information being periodically exchanged.

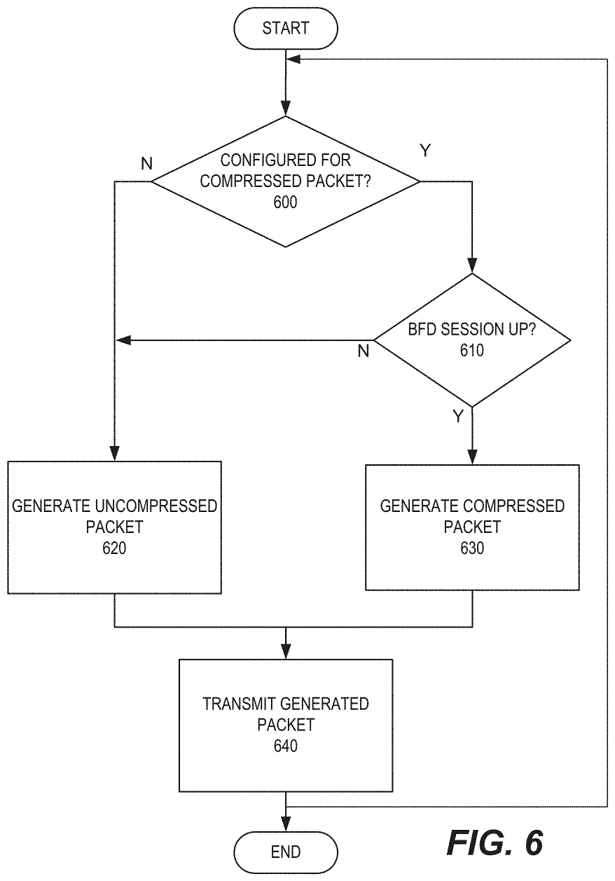

FIG. 6 is a flowchart illustrating aspects of methods of selecting whether to generate a hello packet, such as a BFD control packet, according to a first packet format or according to a second format, where the first format includes at least one field absent from the second format. First, a configuration state detector component (e.g., 216) of a first device (e.g., 210) may detect a configuration state present within the first device and/or a network (e.g., 200) to which the first device is connected. (Block 600). For example, the configuration condition detector may investigate a control setting or configuration setting that indicates whether a BFD component (e.g., 212) should generate a packet according to the first packet format or according to the second packet format.

Subsequent to detection of network conditions and/or configuration states, the configuration state detector component 216 and/or the BFD component 211 of the first device 210 may detect whether a BFD session has been established between the first device 210 and a peer (second) device 220. (Block 610) If the configuration state and the status of the BFD session indicate that compressed hello packets may be generated in which some information is omitted, then the second packet format may be selected (“Y” from Block 610). For example, the second packet format may be the format of the compressed BFD control packet 150 of FIG. 5, and generating the hello packet according to the second packet format may include generating a compressed BFD control packet as discussed with reference to FIG. 5. (Block 630).

Alternatively, if the configuration state and/or BFD session status indicate that full hello packets should be generated that include more fields, then the first packet format may be selected (“N” branches from Blocks 600 and 610). For example, the first packet format may be the format of the uncompressed BFD control packet 50 of FIG. 3, and generating the hello packet according to the first packet format may include generating an uncompressed BFD control packet as discussed with reference to FIG. 3. (Block 620). The hello packet generated according to the first format or the second format is then transmitted (Block 640).

In some embodiments, a generated compressed BFD control packet 150 may include a different value in the version field V, for example 2. In some embodiments, the generated compressed BFD control packet 150 may include a different value in the length field L, for example 8.

In some embodiments, the first device 210 may be configured to transmit generated compressed packets for a minimum of at least 1 detection time period. If the peer system (e.g., the second device 220) is also configured with control setting or configuration setting that indicates the a BFD component (e.g., 222) should generate compressed control packets, the at least one detection time period may enable the peer system to process a compressed packet and/or generate and transmit a compressed packet within the detection time period. If the peering system is not configured to receive and/or generate compressed packets, the compressed packet may be dropped by the peer system 220 and the BFD session may be brought down.

In some embodiments, the first and second system 210 and 220 may boot-strap a BFD session therebetween using uncompressed BFD control packets 50. Once the session is established, and at-least 1 detection time period (detection time=3.3 ms×3) is completed, each system 210 and 220 may then begin generation of compressed BFD control packets 150. Each should continue to transmit the compressed BFD control packets 150 for a minimum of 1 detection time interval to give the other system 210 and 220 a chance to receive and process the compressed packet 150. Additionally, each system 210 and 220 may continue to receive compressed BFD control packets 50 from the peer for a minimum of 1 detection time period to give the peer system 210, 220 time to switch from generating uncompressed BFD control packets 50 to generating compressed BFD control packets 150. In some embodiments, after the at least one detection time interval, if the peer system 220 has not transitioned to reception and generation of compressed BFD control packets 150, the session may be brought down by the first system 210 due to a mismatch in the BFD capability.

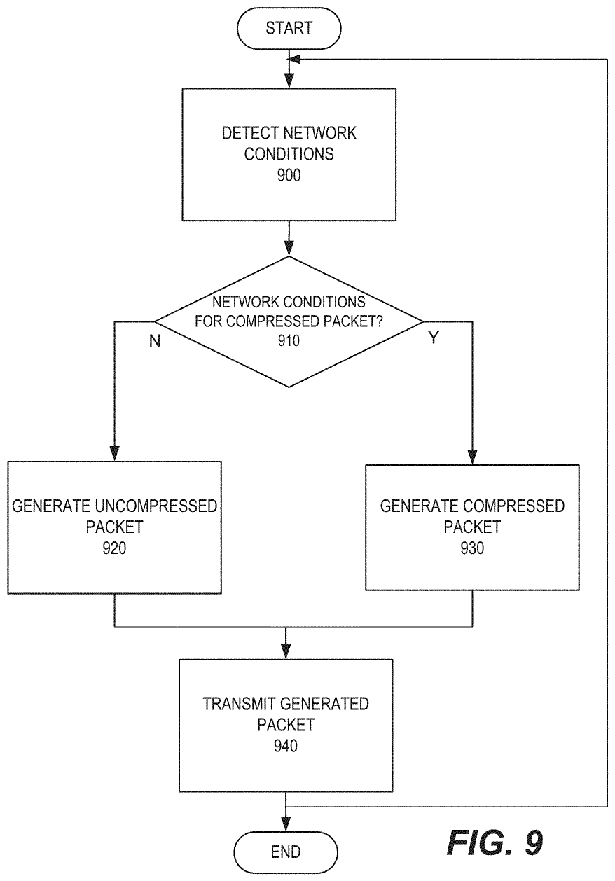

FIG. 9 is a flowchart illustrating aspects of methods of selecting whether to generate a hello packet, such as a BFD control packet, according to a first packet format or according to a second format, where the first format includes at least one field absent from the second format. First, a network condition detector component (e.g., 218 of FIG. 8) of a first device (e.g., 210) may detect a configuration state and/or network condition present within the first device and/or a network (e.g., 200) to which the first device is connected. (Block 900). In some embodiments, for example, where multiple hello packets are generated sequentially, detecting a condition present within the network may include detecting a change in a network condition and/or configuration state present within the network as compared to previously detected conditions. The network condition detector may detect that the networking system 200 is relatively more stable, or the network condition detector 218 may detect that the networking system 200 is relatively less stable. Indicators of less relative stability may include, for example, that a BFD session is in the process of being established between BFD components (e.g., 212, 222) of the first device and a second device (e.g., 220), that a configuration state change has been requested in a BFD session between the first system 210 and the second system 220, and/or that there is networking flap in the routing topology, which in some embodiments may be indicated by a routing protocol component (e.g., 211, 221).

Subsequent to detection of network conditions and/or configuration states, the network condition detector component 218 and/or the BFD component 211 of the first device 210 may use an indication of the detected network condition or configuration state to select between a first packet format and a second packet format for generation of a hello packet (BFD control packet). (Block 910) The first packet format may include one field absent from the second packet format. For example, if the network conditions or configuration state are relatively more stable such that compressed hello packets may be generated in which some information is omitted, then the second packet format may be selected (“Y” from Block 910). For example, the second packet format may be the format of the compressed BFD control packet 150 of FIG. 5, and generating the hello packet according to the second packet format may include generating a compressed BFD control packet as discussed with reference to FIG. 5. (Block 930).

Alternatively, if the network conditions or configuration state are relatively less stable such that full hello packets should be generated that include more fields, then the first packet format may be selected (“N” branch from Block 910). For example, the first packet format may be the format of the uncompressed BFD control packet 50 of FIG. 3, and generating the hello packet according to the first packet format may include generating an uncompressed BFD control packet as discussed with reference to FIG. 3. (Block 920). The hello packet generated according to the first format or the second format is then transmitted (Block 940).

In some embodiments, generating the compressed packet at Block 930 may include selecting one or more of the fields present (and/or required) in the uncompressed packet format, and omitting the one or more selected fields in the generated compressed packet. In other words, although the example compressed BFD control packet 150 of FIG. 5 shows omission of the four-byte transmitting system discriminator 62, the four-byte desired minimum control packet transmission interval 64, the four-byte required minimum control packet reception interval 65, and the four-byte transmitting system required minimum echo packet reception interval 66, in some embodiments a compressed BFD control packet may be generated that includes one or more of these fields, while omitting others of the fields.

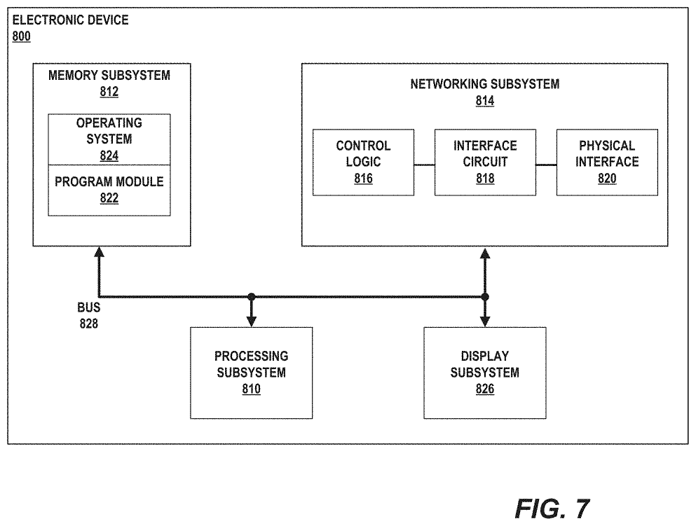

FIG. 7 provides a block diagram of an example of an electronic device, aspects or components of which may be present in the various electronic devices described herein (e.g., the first and second systems 10, 20, 210, 220, the switches of FIGS. 1 and 2, network-enabled devices connected to the networking systems 100 and 200, and so on). FIG. 7 presents a block diagram illustrating an electronic device 800 in accordance with some embodiments. The electronic device 800 may include a processing subsystem 810, a memory subsystem 812, and a networking subsystem 814.

The processing subsystem 810 may include one or more devices configured to perform computational operations. For example, the processing subsystem 810 can include one or more microprocessors, ASICs, microcontrollers, programmable-logic devices, and/or one or more digital signal processors (DSPs).

The memory subsystem 812 may include one or more devices for storing data and/or instructions for the processing subsystem 810 and/or the networking subsystem 814. For example, the memory subsystem 812 can include dynamic random access memory (DRAM), static random access memory (SRAM), and/or other types of memory. In some example embodiments, instructions for the processing subsystem 810 stored in the memory subsystem 812 include: one or more program modules or sets of instructions (such as a program module 822 or an operating system 824), which may be executed by the processing subsystem 810. Note that the one or more computer programs may constitute a computer-program mechanism. In some embodiments, the memory subsystem 812 may be coupled to or may include one or more storage devices (not shown). For example, the memory subsystem 812 can be coupled to a magnetic or optical drive, a solid-state drive, or another type of mass-storage device. In these embodiments, the memory subsystem 812 can be used by electronic device 800 as fast-access storage for often-used data, while the storage device is used to store less frequently used data.

The networking subsystem 814 may include one or more devices configured to couple to and communicate on a wired and/or wireless network (i.e., to perform network operations), including: control logic 816, an interface circuit 818 and one or more interfaces 820 (e.g., ports, antennas, antenna elements). For example, the networking subsystem 814 can include an Ethernet networking system, a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), and/or another networking system. The networking subsystem 814 may include processors, controllers, radios/antennas, sockets/plugs, and/or other devices used for establishing a connection using each supported networking system, coupling to each supported networking system, communicating on each supported networking system, and handling data and events for each supported networking system. Note that mechanisms used for establishing connections, coupling to networks, communicating on networks, and handling data and events on the network for each network system are sometimes collectively referred to as a ‘network interface’ for the network system.

Within an electronic device 800, the processing subsystem 810, the memory subsystem 812, and the networking subsystem 814 may be coupled together using a bus 828. The bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 may include a display subsystem 826 for displaying information on a display (not shown), which may include a display driver and the display, such as a liquid-crystal display, a multi-touch touchscreen, etc.

The electronic device 800 can be (or can be included in) any electronic device with at least one network interface. For example, the electronic device 800 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a controller, a router, a switch, communication equipment, test equipment, and/or another electronic device.

Although specific components are used to describe the electronic device 800, in some example embodiments, different components and/or subsystems may be present in electronic device 800. For example, the electronic device 800 may include one or more additional processing subsystems, memory subsystems, networking subsystems, and/or display subsystems. Additionally, one or more of the subsystems may not be present in an example electronic device 800. Moreover, in some embodiments, the electronic device 800 may include one or more additional subsystems that are not shown in FIG. 7. Also, although separate subsystems are shown in FIG. 7, in some embodiments some or all of a given subsystem or component can be integrated into one or more of the other subsystems or component(s) in an electronic device 800. For example, in some embodiments the program module 822 may be included in the operating system 824 and/or the control logic 816 may be included in the interface circuit 818.

The foregoing descriptions of embodiments of the present disclosure have been presented for purposes of illustration and description only. They are not intended to be exhaustive or to limit the present disclosure to the forms disclosed. Accordingly, many modifications and variations of the inventive concepts will be apparent to those skilled in the art, and the inventive concepts defined herein may have applicability to other embodiments and applications without departing from the scope of the present disclosure.

What is claimed is:

1. A method comprising:
detecting, by a first device, a configuration state present within a network to which the first device is connected;
selecting, by the first device and based on the detected configuration state, between a first format and a second format to be used in generating a hello packet for transmission via the network to a second device, wherein the first format requires at least one field that is absent from the second format;
generating, by the first device, the hello packet according to the selected first or second format; and
transmitting, by the first device, the generated hello packet to the network.

2. The method of claim 1, wherein the hello packet is a bidirectional forwarding detection protocol (BFD) control packet.

3. The method of claim 2, wherein the detecting of the configuration state present within the network comprises detecting that the first device is establishing a BFD session with the second device, and wherein the selecting comprises selecting the first format.

4. The method of claim 2, wherein the detecting of the configuration state present within the network comprises detecting that the first device or the second device is requesting a configuration change to an established BFD session between the first device and the second device, and wherein the selecting comprises selecting the first format.

5. The method of claim 4, wherein the requesting of the configuration change to the established BFD session is responsive to user input.

6. The method of claim 2, wherein the first format comprises a field for a discriminator value corresponding to the first device, and wherein the field for the discriminator value corresponding to the first device is absent from the second format.

7. The method of claim 2, wherein the first format comprises a field for a minimum BFD control packet transmission interval value desired by the first device, and wherein the field for the minimum BFD control packet transmission interval value desired by the first device is absent from the second format.

8. The method of claim 2, wherein the first format comprises a field for a minimum BFD control packet reception interval value supported by the first device, and wherein the field for the minimum BFD control packet reception interval value required by the first device is absent from the second format.

9. The method of claim 2, wherein the first format comprises a field for a minimum BFD echo packet transmission interval value required by the first device, and wherein the field for the minimum BFD echo packet transmission interval value required by the first device is absent from the second format.

10. A networking system comprising:
a first networking device; and
a second networking device in communication with the first networking device via a network;
wherein the first networking device is configured to: detect a configuration state present within the network; select, based on the detected configuration state, between a first format and a second format to be used in generating a hello packet for transmission via the network to the second networking device; generate the hello packet according to the selected first or second format; and transmit the hello packet to the network, and
wherein the first format requires at least one field that is absent from the second format.

11. The networking system of claim 10, wherein the hello packet is a bidirectional forwarding detection protocol (BFD) control packet.

12. The networking system of claim 11, wherein the first networking device is configured to detect that the first networking device is establishing a BFD session with the second networking device, and in response select the first format.

13. The networking system of claim 11, wherein the first networking device is configured to detect that the first networking device or the second networking device is requesting a configuration change to an established BFD session between the first networking device and the second networking device, and in response select the first format.

14. The networking system of claim 11, wherein the first format comprises a field for a discriminator value corresponding to the first networking device, and wherein the field for the discriminator value corresponding to the first networking device is absent from the second format.

15. The networking system of claim 11, wherein the first format comprises a field for a minimum BFD control packet transmission interval value desired by the first networking device, and wherein the field for the minimum BFD control packet transmission interval value desired by the first networking device is absent from the second format.

16. The networking system of claim 11, wherein the first format comprises a field for a minimum BFD control packet reception interval value supported by the first networking device, and wherein the field for the minimum BFD control packet reception interval value required by the first networking device is absent from the second format.

17. A networking system comprising:
a first networking device configured to: detect a configuration state present within a network; select, based on the detected configuration state, between a first format and a second format to be used in generating a hello packet for transmission via the network to a second networking device; generate the hello packet according to the selected first or second format; and transmit the hello packet to the network,
wherein the first format requires at least one field that is absent from the second format, and
wherein the hello packet is a bidirectional forwarding detection protocol (BFD) control packet.

18. The networking system of claim 17, wherein the first networking device is configured to detect that the first networking device is establishing a BFD session with the second networking device, and in response select the first format.

19. The networking system of claim 17, wherein the first networking device is configured to detect that the first networking device or the second networking device is requesting a configuration change to an established BFD session between the first networking device and the second networking device, and in response select the first format.

20. The networking system of claim 17, wherein the first format comprises a field for a discriminator value corresponding to the first networking device, and wherein the field for the discriminator value corresponding to the first networking device is absent from the second format.
